(19) United States
(12) Patent Application Publication
(10) Pub. No.: US 2007/0062392 A1
(43) Pub. Date: Mar. 22, 2007

(54) Device for distributing flat articles using a transport system

(76) Inventor: Holger Ratz, Frankenthal (DE)

Correspondence Address: Douglas R. Hanscom;Jones, Tullar & Cooper, P.O. Box 2266 Eads Station, Arlington, VA, 22202, US

(21) Appl. No.: 10/575,921

(22) PCT Filed: Oct. 13, 2004
(86) PCT No.: PCT/EP04/52525

§ 371 Date: Apr. 14, 2006

(30) Foreign Application Priority Data
Oct. 14, 2003 (DE) 10347572.9

(51) Int. Cl. B41F 13/54

(52) U.S. Cl. 101/227

(57) ABSTRACT

Flat objects are distributed by a device which includes a transport section that is used to transport a stream of flat objects to be distributed, and a plurality of sequentially arranged paddle wheels or delivery fans, each of which has at least one component that is configured to receive an object from the transport section. Each paddle wheel delivers its object to a distribution point. The paddle wheels can be rotated, with respect to each other, to provide a phase shift which permits each of a number of objects, which corresponds to the number of paddle wheels in the sequence, to be received by a compartment of a different one of the number of paddle wheels.

### CROSS-REFERENCE TO RELATED APPLICATIONS

This application is the U.S. national phase, under 35 U.S.C. 371, of PCT/EP2004/052525, filed Oct. 13, 2004; published as WO2005/035409 A1 on Apr. 21, 2005 and claiming priority to DE 103 47 572.9, filed Oct. 14, 2003, the disclosures of which are expressly incorporated herein by reference.

### FIELD OF THE INVENTION

The present invention is directed to a device and to a method for delivering flat objects by the use of a conveying track. The flat objects are deposited in a plurality of paddle wheels or delivery fans that have object receiving compartments which are out of phase with each other.

### BACKGROUND OF THE INVENTION

A delivery device is typically employed, in particular, at an outlet of a rotary printing press, to deliver individual signatures, formed from a continuous web of imprinted paper webs, to a plurality of conveyor belts. A generally known delivery device of this type is described, for example, in DE 101 16 346 A1. This generally known device employs conveying tracks, in which a signature is conveyed, while it is clamped between endless belts, which belts are looped around a plurality of rollers. To distribute the signatures to different delivery points, the conveying track is forked several times. A signature shunt, in the form of a wedge, is located at each of the respective forks, which shunt can be moved back and forth and which, depending on its position, diverts a passing signature into different directions. In this way the device conducts the signatures to different branches of the conveying track. To distribute a flow of signatures, with the aid of such a signature shunt and over two different paths, the signature shunt must be able to change its position between respectively two passages of signatures. This is only possible if the signatures do not directly follow each other. If the signatures are cut from a continuous web, such a spacing distance between successive signatures can only be achieved if the speed of the conveying track is clearly greater than the speed of the web prior to cutting of the web to form the signatures. The shorter that the distance is, between two successive signatures, at the level of the shunt, the faster the shunt must be able to switch. This leads to considerable demands being made on the mechanical system of the signature shunt. Such demands can only be met with considerable technical outlay and with corresponding costs.

U.S. Pat. No. 5,236,188 describes a method for depositing printed products, having several paddle wheels arranged next to each other. A separate transfer cylinder with grippers is required for each paddle wheel between a transport track with conveyor belts.

FR 2 760 733 discloses a paddle wheel with two paddles.

DE 100 03 284 A1 and U.S. Pat. No. 5,485,992 describe two phase-shifted rotating paddle wheels, which alternatingly deposit printed products.

### SUMMARY OF THE INVENTION

The object of the present invention is directed to providing a device and a method for delivering flat objects by the use of a conveying track.

In accordance with the present invention, this object is attained by the provision of a conveying track which is usable to convey a flow of flat objects to be deposited in selected one of a plurality of serially arranged paddle wheels or delivery fans. Each of the several delivery fans has at least one compartment which is adapted to receive one of the flat objects from the conveying track. Each paddle wheel deposits its received one of the flat objects at a deposit location. The several paddle wheels, which are arranged serially in the direction of travel of the conveying track, are rotatable so that the object receiving compartments of the paddle wheels are out of phase.

The advantages which can be achieved by the present invention lie, in particular, in that the device operates without the use of rapidly and discontinuously moved parts, such as, for example, are required by the above-described signature shunt. Furthermore, no large spacing distances are required to be formed between objects which are following each other on the conveying track in order to be able to transport those objects, without problems, to different delivery positions.

Paddle wheels are preferably arranged on at least one side of, or below the conveying track. The objects, which are conveyed on the conveying track, tend to push into a compartment of the paddle wheel because of their inherent weight, if such a compartment is available.

A tip of each paddle, as that tip is crossing the conveying track, while the compartment which is formed by the paddle adjoins the conveying track, is used to catch the front end of an object that is situated on the conveying track at the level of the compartment of a paddle. This paddle tip is used to guide the object into the compartment. To this end, it is also preferable for the circumferential speed of the paddle to be less than the linear conveying speed of the conveying track.

It is sufficient for the device for distributing flat objects, in accordance with the present invention, if each paddle wheel has only a single paddle and thus has only a single object receiving compartment. It is also possible, in accordance with the present invention, to provide two paddles in each paddle wheel. This simplifies the balancing of the paddle wheels and, in comparison with the embodiment provided with a single paddle, makes no noticeable increase of the circumference of the paddle wheel necessary.

Adjacent ones of the sequentially arranged paddle wheels preferably have a mutual phase shift of 2 π (d/vT±1/mN), wherein d is the distance between the paddle wheels, N is the number of paddle wheels, m is the number of their paddles, v is the conveying speed of the conveying track and T is the time interval between two objects conveyed on the conveying track. This phase difference assures that two objects successively conveyed on the conveying device are taken over by the N paddle wheels, in a cyclically alternating manner.

Preferably, the number N of the paddle wheels is four. If the device of the present invention is employed in connection with a printing press, whose plate cylinder can take on four plates or can print four images in the circumferential direction, the device with four paddle wheels allows it to deliver printed products, which were printed by the same respective printing plates or which have the same print images, at the same location. In this way, the printed products following each other are sorted cyclically on the conveying track.

If the device of the present invention is used for receiving and distributing printed products, a transverse cutting device is preferably placed upstream of the devices. This cutting device cuts an imprinted web of material, or a continuous strand of webs of material into individual printed products.

A vertical section of the conveying track is preferably arranged following the transverse cutting device, which vertical section can be used to space the individual printed products, which are delivered to the conveying track by the transverse cutting device, apart from each other on the conveying track. The paddle wheels are preferably serially or sequentially arranged along a horizontal section of the conveying track in order to make the delivery of the individual flat objects or products into the compartments of the paddle wheels simpler.

### BRIEF DESCRIPTION OF THE DRAWINGS

Preferred embodiments of the present invention are represented in the drawings and will be described in greater detail in what follows.

Shown are in:

FIG. 1, a schematic side elevation view through the device in accordance with the present invention, in

FIG. 2, an enlarged detail of a portion of the device, and in

FIG. 3, a modification of the paddle wheel of the device.

### DESCRIPTION OF THE PREFERRED EMBODIMENT

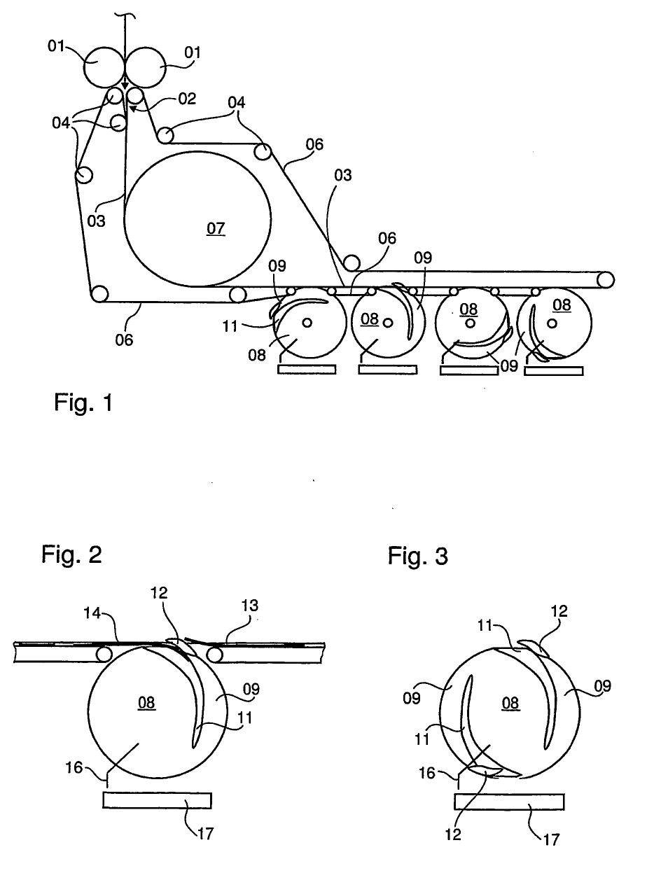

An inlet of the device for transporting flats objects in accordance with the present invention, as represented in FIG. 1, is constituted by a transverse cutting device 01, such as, for example, a cutting cylinder pair 01. As illustrated by an arrow, a strand of imprinted webs of material, such as, for example, paper webs, is fed from above out of a superstructure, which is not specifically represented, to the cutting cylinder pair 01. One cylinder of the cutting cylinder pair 01 has a cutter which, in cooperation with a countersupport of the other cylinder of the cutting cylinder pair 01, cuts a section, having the size of a page, off from the strand during every revolution of the cutting cylinder pair 01. The object which is obtained in this manner, and in particular which object is a printed product, enters an inlet nip 02 of a conveying track 03. Conveying track 03 is constituted by endless belts 06, such as, for example, by transport belts 06, which are circulating over a plurality of belt guide rollers 04. A circulating speed of the endless belts 06 is greater, by approximately 5%, than is the speed of the paper webs being fed to the cutting cylinder pair 01. The individual products are thus gradually accelerated in the inlet nip 06 of the conveying track 03, which track 03 gradually tapers in the downward direction. A gap or a spacing of approximately 5% of their lateral length results between successive printing products due to the increased speed of the endless belts 06.

The initially vertically extending conveying track 03 now makes a transition into a horizontal orientation as it passes around a roller 07 having a large diameter. The function of the large diameter roller 07 can be solely the deflection of the conveying track 03. Roller 07 could also be a generally known collecting cylinder 07, on which each printed product is collected and makes at least one complete revolution. In a process, which is generally known, each such printed product on the collecting cylinder is combined with at least one other printed product to form a stack. The collected printed products are finally passed on, as a stack, for further conveyance.

The roller 07 can also be embodied as a folding blade cylinder 07.

The printed products, which are delivered from the roller 07, move along over a horizontal section of the conveying track 03, along which section of track 03 a number N of paddle wheels 08, depicted in FIG. 1 as four such paddle wheels 08, each with only a single paddle or compartment, are arranged one behind the other or sequentially in the direction of travel of the horizontal section of the conveying track 03. The paddle wheels 08 are arranged or are spaced at an even distance “d” from each other and all rotate at the same speed. A phase shift of 2 π (d/vT±1/mN) exists between adjoining paddle wheels 08, wherein v indicates the speed of the endless belts of the conveying track 03 and T indicates the time interval between two successive printed products on the conveying track 03. A section of the conveying track 03 is arranged between each of the sequentially two paddle wheels 08. The selection of the phase difference between the paddle wheels 08 assures that each time a printed product is located above a paddle wheel 08, either the compartment 11 of that paddle wheel 08 faces the printed product, so that the printed product can enter into the compartment 11 of that paddle wheel, or the compartment 11 of that paddle wheel is offset by ±¼ or ½ of a revolution. Conveyed products are conveyed to successive ones of the sequentially positioned paddle wheels and are taken in, one after the other, by the respective compartments 11 of the first, second, third, fourth, and then again by the compartment of the first paddle wheel 08, or are taken in by the compartments 11 in a reverse order.

The paddle wheels 08 are each formed using a plurality of substantially circular, spaced disks, which disks can be rotated, on one level, around common axes of rotation, and into each of which circular disks a compartment 11 has been cut. These paddle wheels 08 all rotate as a circumferential speed which is slightly less than the rotational speed, or the conveying speed of the endless belts 06, and which is preferably identical to the speed of the paper webs that were fed to the cutting cylinder pair 01. Only a free end or free tip 12 of each paddle 09 protrudes at a distance past the circumference of the circular disk, so that during its position in which the free tip 12 faces the conveying track 03, this free tip 12 crosses the conveying track 03, as seen in FIG. 2.

As can also be seen in FIG. 2, the tip 12 deflects the trailing end of the previous printed product 13 slightly upward, while, at the same time, tip 12 constitutes an obstacle to the further travel of the leading edge of a subsequent or following printed product 14. This is because tip 12 moves more slowly than the printed product, and deflects the leading edge of the printed product 14 downward into the compartment 11. It is clear, from the depiction in FIG. 2, that no large distance between successive printed products is required for diverting the printed product 14 out of, or off from the conveying track 03 and into the compartment 11 of the paddle wheel 08. Instead, it is quite desirable to have a rather short spacing between the printed products, so that the printed product 14 is pushed or inserted as deeply as possible into the compartment 11 of its respective paddle wheel 08 before its trailing end loses contact with the endless belts 06 of the conveying track 03.

Tines 16 of a stationary rake extend from below between the axially spaced disks of each paddle wheel 08. These tines 08 are used to push a printed product, which is possibly contained in the compartment 11 of the paddle wheel 08, out of the compartment 11 in the course of the rotation of the paddle wheel 08 in a clockwise direction. The tines 16 serve to deposit the printed product at a deposit location 17, here a conveyor belt 17 which is moving transversely in relation to the plane of FIG. 2.

Even though only four sequentially or serially arranged paddle wheels 08 are represented in FIG. 1, the principle of the present invention can be generalized to utilize any arbitrary number of paddle wheels 08 and deposit locations. The number N of the paddle wheels 08 is a whole number and can be larger than or equal to three. However, it is generally not particularly useful to have more deposit locations 17 than there are different printing products which can be present on the conveying track 03. This means that when the device in accordance with the present invention is used in connection with a printing press whose plate cylinders can support up to four different plates or print images in the circumferential direction, no more than four deposit location 17, corresponding to these four plates or printed images, are usable.

If, as discussed above, the roller 07 is provided as a collecting cylinder 07, which collecting cylinder 07 is operated in a collecting mode and which releases printed products that have been combined from two respective stacked sections, this results, in contrast to operation of the device in the non-collecting mode, to doubling of the period T between which successive ones of the printed products pass the paddle wheels 08. The collected printed products are now deposited at only two of the four deposit locations 17, without a change in the movement of the individual paddle wheels 08 being required.

If there is no operation of the cylinder 07 in the collection mode, but it is still intended to deposit products on only two of the four available deposit locations 17, or conveyor belts 17, this is easily possible with a modification of the paddle wheel 08 in accordance with the present invention, as represented in FIG. 3. This modified paddle wheel 08 has two paddles 09 situated at positions which are diametrically opposite each other. A tip 12 of at least one of the paddles 09 can be pivoted between the position represented in FIG. 2, in which tip 12 projects past the circumference of the circular plate of the paddle wheel 08, and a lowered position in which tip 12, as represented at the bottom of FIG. 3, does not project past the circumference. Instead, in the lowered position, tip 12 closes off the compartment 11 in which it is arranged. If, for example, such a paddle wheel 08, in accordance with the second preferred embodiment, is mounted in the position next adjoining the roller 07 in FIG. 1 it acts, so long as the second tip 12 is lowered, no differently than a paddle wheel 08 with a single paddle 09. However, when the tip 12 is pivoted out, this paddle wheel 08 catches every second printed product passing it. If the paddle wheel 08 of the type represented in FIG. 3 is also mounted in the second next position to the roller 07 in FIG. 1, it is possible to make deposits selectively on two, three or four conveyor belts 17.

It is also within the scope of the present invention to provide a paddle wheel, which is not specifically represented, at the first position, which first position paddle wheel has four paddles 09 at respective paddle spacing distances of 900. At least three of these paddles 09 would have pivotable tips. If all of these tips are pivoted out, such a paddle wheel will catch all of the printed products passing on the conveying track 03 and will deposit them on the associated conveying belt 17.

The device in accordance with the present invention, as depicted in FIG. 1, picks up first identical objects in the first paddle wheel 08, and second identical objects, differing from the first objects, in the second paddle wheel 08. Third identical objects are picked up in the third paddle wheel 08, and in the fourth paddle wheel 08, fourth identical objects, differing from the third objects, are picked up or received.

Preferably, each paddle wheel 08 has fewer than five paddles 09, and in particular preferably has fewer than three paddles 09.

The flat objects are transported by the use of the conveying track 03 and the paddle wheels 08. In the process, the objects are transported one behind the other along the conveying track 03. A first one of these objects is taken out of the conveying track 03 and is transported into a compartment 11 of a first paddle wheel 08. The remaining objects continue to be transported along the conveying track 03 to a second paddle wheel 08, which is located downstream of the first paddle wheel 08 in relation to the transport direction of the conveying track 03. A second one of these objects is taken from the conveying track 03 and is transported into a compartment 11 of the second paddle wheel 08.

Thereafter, the remaining objects are transported along the conveying track 03 to a third paddle wheel 08, which is located downstream of the second paddle wheel 08, in relation to the transport direction of the conveying track 03, and a third one of these objects is taken from the conveying track 03 and is transported into a compartment 11 of the third paddle wheel 08.

The remaining objects are transported along the conveying track 03 to a fourth paddle wheel 08, which is located downstream of the third paddle wheel 08, in relation to the transport direction of the conveying track 03. A fourth one of these objects is taken from the conveying track 03 and is transported into a compartment 11 of the fourth paddle wheel 08.

The number N, which is used to indicate the number of sequentially arranged paddle wheels, can also correspond to the number of the different objects arranged one behind the other on the conveying track 03. Each different one of the objects is received repeatedly in its corresponding one of the serially or sequentially arranged paddle wheels.

While preferred embodiments of a device for distributing flat objects using a transport section, in accordance with the present invention, have been set forth fully and completely hereinabove, it will be apparent to one of skill in the art that various changes in, for example, the type of web being printed, the types of printing units used to print the web, and the like, could be made without departing from the true spirit and scope of the present invention, which is accordingly to be limited only by the appended claims.

What is claimed is:

1-28. (canceled)

29. A device for conveying a flow of flat object comprising:
a conveying track having a plurality of spaced conveyor belts and adapted to receive a flow of flat objects to be conveyed in a conveying direction by said conveying belt;
a plurality of rotatable paddle wheels spaced sequentially along said conveying track in said conveying direction, each of said paddle wheels being adjacent said spaced conveyor belts;
means supporting each of said plurality of paddle wheels for rotation about an axis of rotation;
at least one paddle on each said paddle wheel and defining an object receiving compartment, a maximum number of paddles on each said paddle wheel being four;
a tip on each said paddle of each said paddle wheel, said tip being positioned to cross said conveying track while said compartment associated with said tip adjoins said conveying track and wherein said paddle wheels are rotated with respect to each other having a phase shift of said at least one compartment of each said paddle whereby a number of objects are received in respective ones of said compartments of said number of said sequentially arranged paddle wheels, said number of objects and paddle wheels being a whole number of at least three; and
a deposit location adapted to receive said flat objects from said paddle wheels.

30. The device of claim 28 wherein said paddle wheels are located below said conveying track.

31. The device of claim 29 wherein said conveying belt has a conveying speed and said paddle wheels have a circumferential speed which is less than said conveying speed.

32. The device of claim 29 wherein each of said paddle wheels has less than three paddles.

33. The device of claim 29 wherein adjacent ones of said sequentially spaced paddle wheels have said phase shift with respect to each other defined by
2 π (d/vT±1/mN) wherein:
d is a spacing distance between said paddle wheels; m is said number of paddles, N is said number of paddle wheels; v is a conveying speed of said conveying belt; and T is a time interval between successive ones of said objects on said conveying belt.

34. The device of claim 29 wherein said number of paddles is four.

35. The device of claim 29 further including a transverse cutting device located before, in a direction of travel of said objects, said conveying belt.

36. The device of claim 29 wherein said conveying track has a horizontal section, said plurality of paddle wheels being spaced along said horizontal section of said conveying track.

37. The device of claim 35 wherein said conveying track includes a vertical section, after, in said direction of travel of said objects, said transverse cutting device.

38. The device of claim 29 wherein a section of said conveying track is arranged between each two of said plurality of sequentially spaced paddle wheels.

39. The device of claim 29 wherein said plurality of paddle wheels are arranged on one side of said conveying track.

40. The device of claim 29 wherein first identical ones of said objects are secured in a first one of said paddle wheels, and second identical ones of said objects, different from said first objects, are secured in a second one of said paddle wheels.

41. The device of claim 40 further wherein third identical objects, different from said first and second objects, are received in a third one of said paddle wheels.

42. The device of claim 41 further wherein fourth identical objects, different from said first, second and third objects, are received in a fourth one of said paddle wheels.

43. The device of claim 29 wherein said axes of rotation of said plurality of paddle wheels are arranged on one level.

44. The device of claim 29 wherein said objects are printed products.

45. The device of claim 29 further including a folding blade cylinder adapted to transversely fold said flat objects.

46. The device of claim 29 further including a collecting cylinder for said flat objects.
